(19) United States
(12) Patent Application Publication
(10) Pub. No.: US 2020/0219159 A1
(43) Pub. Date: Jul. 9, 2020

(54) Real-Time Collaborative Product Configurator

(71) Applicant: Dell Products L.P., Round Rock, TX (US)

(72) Inventors: Smita Choudhary, Jharkhand (IN); Sunitha Arram, Telangana (IN)

(73) Assignee: Dell Products L.P., Round Rock, TX (US)

(21) Appl. No.: 16/242,154

(22) Filed: Jan. 8, 2019

(51) Int. Cl. G06Q 30/06; G06Q 30/02; G06F 3/0484; G06F 16/955

(52) U.S. Cl. CPC G06Q 30/0621; G06F 16/955; G06F 3/0484; G06Q 30/0281

(57) ABSTRACT

A system, method, and computer-readable medium are disclosed for collaboratively configuring a product in an online environment. The collectively configuring is accomplished by performing a collaborative product configuration operation which includes: receiving a request from a customer to a sales representative to collaboratively configure a product; generating a product configuration based upon the request; and, publishing the product configuration via a collaborative product configurator system, the collaborative product configuration system performing the collaborative product configuration operation, the collaborative product configuration operation enabling the customer and the sales representative to interactively configure the product.

### BACKGROUND OF THE INVENTION

### Field of the Invention

The present invention relates to information handling systems. More specifically, embodiments of the invention relate to collaboratively configuring a product in an online environment.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

A system, method, and computer-readable medium are disclosed for collaboratively configuring a product in an online environment.

More specifically, in one embodiment the invention relates to a computer-implementable method for performing a collaborative product configuration operation, comprising: receiving a request from a customer to a sales representative to collaboratively configure a product; generating a product configuration based upon the request; and, publishing the product configuration via a collaborative product configurator system, the collaborative product configuration system performing the collaborative product configuration operation, the collaborative product configuration operation enabling the customer and the sales representative to interactively configure the product.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: receiving a request from a customer to a sales representative to collaboratively configure a product; generating a product configuration based upon the request; and, publishing the product configuration via a collaborative product configurator system, the collaborative product configuration system performing the collaborative product configuration operation, the collaborative product configuration operation enabling the customer and the sales representative to interactively configure the product.

In another embodiment the invention relates to a computer-readable storage medium embodying computer program code, the computer program code comprising computer executable instructions configured for: receiving a request from a customer to a sales representative to collaboratively configure a product; generating a product configuration based upon the request; and, publishing the product configuration via a collaborative product configurator system, the collaborative product configuration system performing the collaborative product configuration operation, the collaborative product configuration operation enabling the customer and the sales representative to interactively configure the product.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a collaborative product configurator environment.

FIG. 3 shows a functional process flow diagram of the operation of a collaborative product configurator system.

FIG. 4 is a flowchart showing the performance of collaborative product configuration operations.

### DETAILED DESCRIPTION

A system, method, and computer-readable medium are disclosed for collaboratively configuring a product in an online environment. Certain aspects of the invention reflect an appreciation that it is not uncommon for an ecommerce customer to experience multiple interactions with a sales representative to purchase a configurable product, described in greater detail herein. As an example, it may require multiple iterations to make changes to product configurations, pricing, quantities, and so forth.

Certain aspects of the invention likewise reflect an appreciation that current approaches to product configuration include the use of an online shopping cart to present a proposed product configuration to the customer. In certain of these approaches, the proposed product configuration stored in the cart is provided via an email message to the customer. Accordingly, a new email message is generated and sent to the customer every the product configuration is revised. In turn, the customer responds to the revisions, which may result in another iteration of revisions by sales representative, with the process continuing until the product configuration meets the desires or needs of the customer. Consequently, such approaches are not conducive to a customer and sales representative collaboratively configuring a product.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

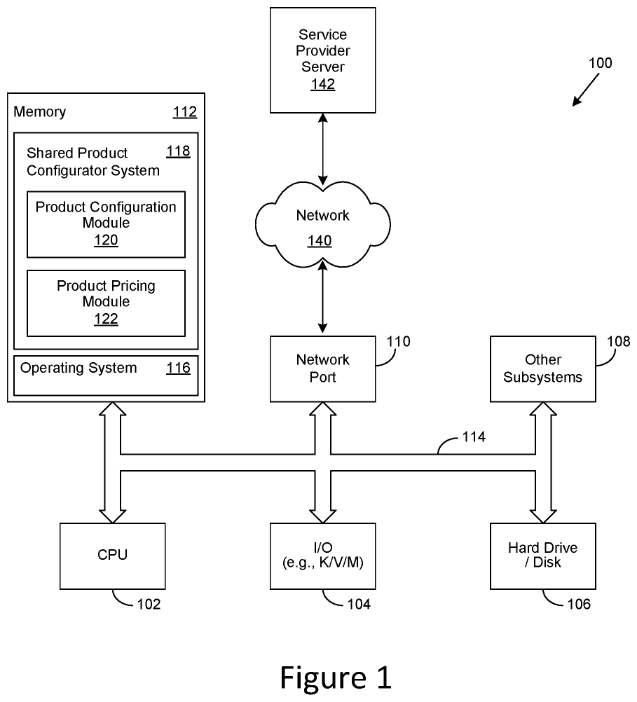

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a collaborative product configurator system 118. In one embodiment, the information handling system 100 is able to download the collaborative product configurator system 118 from the service provider server 142. In another embodiment, various functions associated with the collaborative product configurator system 118 are provided as a service from the service provider server 142.

The collaborative product configurator system 118performs a collaborative product configurator operation. The collaborative product configurator system 118 operation improves processor efficiency, and thus the efficiency of the information handling system 100, facilitating the collaborative product configurator operation. In certain embodiments, the collaborative product configurator operation can be performed during operation of the information handling system 100. As will be appreciated, once the information handling system 100 is configured to perform the collaborative product configurator operation, the information handling system 100 becomes a specialized computing device specifically configured to perform the collaborative product configurator operation and is not a general purpose computing device. Moreover, the implementation of the collaborative product configurator operation on the information handling system 100 improves the functionality of the information handling system 100 and provides a useful and concrete result of providing a sales representative and a customer collaborative access to certain product configuration information when performing various collaborative product configurator operations. In certain embodiments, the collaborative product configurator operation results in shortening the time required to configure a product.

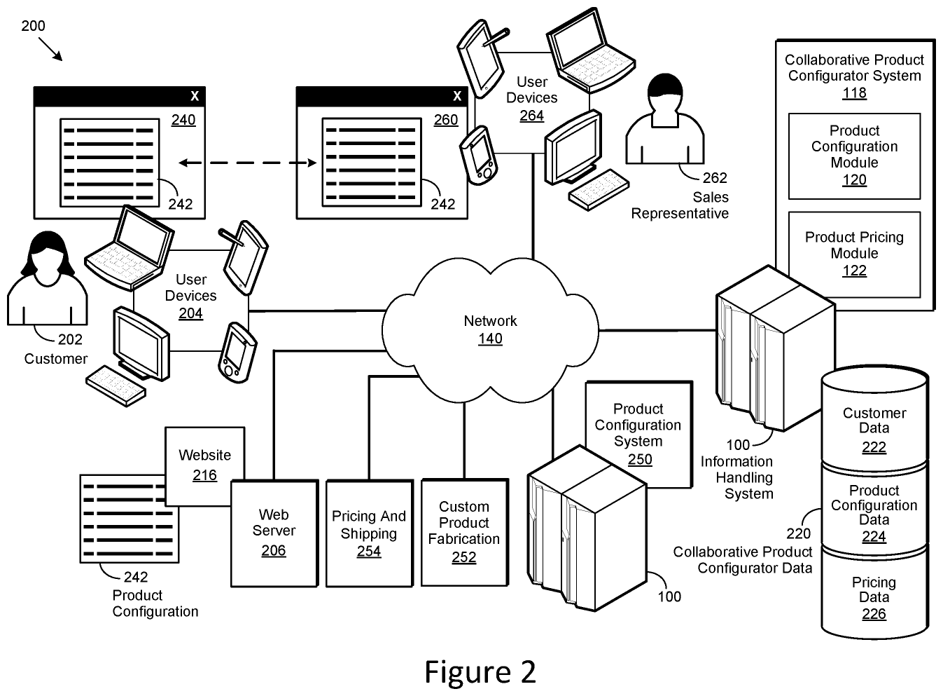

FIG. 2 is a block diagram of a collaborative product configuration environment 200 implemented in accordance with an embodiment of the invention. As used herein, a product broadly refers to anything that can be offered to a market to satisfy a desire or a need of a customer 202. In a retail environment, products are often referred to as merchandise. Likewise, products are often referred to as finished goods in a commercial environment. In either case, products may be mass produced or configurable. As an example, an information handling system 100 may be configured to have a certain class and speed of processor, a certain amount of main memory, a particular storage device, and a graphics processor with certain capabilities.

Skilled practitioners of the art will recognize that products may be tangible or intangible. As used herein, a tangible product broadly refers to a physical object that can be perceived by touch. Examples of tangible products include building materials, vehicles, clothing, computing and communication devices, office supplies, and so forth. As likewise used herein, an intangible product broadly refers to a durable or non-durable consumable item that does not have a physical nature. Instead, an intangible product has certain characteristics that can be perceived indirectly. Examples of intangible products include insurance policies, digital goods, (e.g., downloadable music, mobile apps, and virtual goods, such as those used in Internet games), and various services, whether they are delivered in a physical or online environment.

As used herein, services broadly refer to resources, processes, and systems, or a combination thereof, that are assigned for service delivery during a specified period of time. Examples of a service delivered in a physical environment include educational curriculums and training courses conducted in a classroom setting, warranty repair or replacement of a product, whether the product is tangible or intangible, various household maintenance procedures, and so forth. Likewise, examples of a service delivered in an online environment include services provided via a cloud computing environment. As used herein, such cloud services broadly refer to various information technology (IT) and computing services provided on-demand over the Internet, or a dedicated network, with payment based upon usage. In certain embodiments, the cloud computing services may include Infrastructure as a Service (IaaS), Platform as a Service (PaaS), Software as a Service (SaaS), and Functions as a Service (FaaS).

As likewise used herein, Infrastructure as a Service (IaaS) broadly refers to the provision of IT infrastructure, such as server resources, virtual machines (VMs), network capacity, and so forth, on a pay-as-you-go basis. Likewise, as used herein, Platform as a Service (PaaS) broadly refers to the provision of an on-demand environment for developing, testing, delivering, and managing software applications. As such, a PaaS is typically implemented to quickly create web or mobile apps without the need to set up or manage the underlying infrastructure of servers, storage, network and databases needed for development and deployment. Software as a Service (SaaS), as likewise used herein, broadly refers to a method for delivering software applications over the Internet on an on-demand, subscription basis. As generally implemented, known SaaS approaches use an underlying infrastructure, described in greater detail herein, to facilitate hosting, management, maintenance, and security of a software application.

As used herein, Functions as a Service (FaaS) broadly refers to an additional layer of abstraction to a PaaS, such that developers are insulated from anything implemented in a development stack below their code. Accordingly, the use of PaaS removes the operational overhead of managing virtual servers, containers, and application runtimes. Instead, narrowly functional blocks of code set to be triggered by a certain event are uploaded. Consequently, FaaS applications consume no IaaS resources until an event occurs, which reduces consumption of cloud computing resources and pay-per-use fees. In various embodiments, the implementation of a FaaS may be associated with the provision of certain storage, data, information, applications, communications, integration, security, management, testing, and other functions.

As likewise used herein, a configurable product broadly refers to a product that can be adapted, modified, or customized to accommodate the desires or needs of a particular customer 202 through the selection of various product options. In various embodiments, the product options may include certain product attributes, features, functionalities, and performance options. In certain embodiments, the product options may likewise include various pricing, warranty, support, and delivery options. Skilled practitioners will recognize that many such examples of product options for a configurable product are possible. Accordingly, the foregoing is not intended to limit the spirit, scope or intent of the invention.

In certain embodiments, the collaborative product configurator environment 200 may include a collaborative product configurator system 118. In various embodiments, the collaborative product configurator system 118 may be implemented to allow a customer 202 and a sales representative 262 to interactively configure a configurable product by collaboratively selecting certain product options. In certain embodiments, the collaborative product configurator system 118 may be implemented, as described in greater detail herein, to generate a product configuration 242. As used herein, a product configuration 242 broadly refers to a collection of product options that describe a particular instantiation of a configurable product.

In certain embodiments, the collaborative product configurator environment 200 may include a repository of collaborative product configurator data 220. In certain embodiments, the repository of collaborative product configurator data 220 may be local to the system executing the collaborative product configurator system 118 or may be executed remotely. In certain embodiments, the repository of collaborative product configurator data 220 may include certain information associated with customer data 222, product configuration data 224, and various pricing data 226. In certain embodiments the pricing data 226 may include the base cost of a configurable product, the respective costs associated with various product options, product quantity discounts, shipping costs, and so forth.

In certain embodiments, the collaborative product configurator system 118 may include a product configuration 120 module and a pricing 122 module. In certain embodiments, the product configuration 120 module may be implemented to interact with a product configuration system 250. In various embodiments, the interaction between the product configuration 120 module and the product configuration system 250 may include the provision of certain product option selection information provided by the customer 202 or the sales representative 262. In certain embodiments, product configuration system 250 may be implemented to use the provided product option selection information to generate a product configuration 242.

In certain embodiments, the product configuration system 250 may be executing on a separate information handling system 100. In various embodiments, the product configuration system 250 may be implemented to interact with a custom product fabrication system 252. In various embodiments, the custom product fabrication system 252 may be implemented to fabricate a configurable product. In various embodiments, the custom product fabrication system 252 may be implemented to use certain information associated with a product configuration 242 to manufacture, or otherwise produce, a configurable product.

In certain embodiments, the product pricing 122 module may be implemented to provide pricing information corresponding to a particular product configuration 242. In certain embodiments, the product pricing module 122 may be implemented to interact with various pricing and shipping systems 254. In various embodiments, the product pricing 122 module may be implemented to provide, receive, or a combination thereof, certain collaborative product configurator data 220. As an example, a user 202 and a sales representative 262 may interactively use the collaborative product configurator system 118 to collaboratively generate a particular product configuration 242. In this example, the product configuration 120 module may be implemented to interact with the product configuration system 250, which in turn may be implemented to use certain product configuration data 224 and pricing data 226 to determine a cost for the product configuration 242. To continue the example, the product pricing 122 module may in turn be implemented to use certain customer data 222 and pricing data 226 to determine quantity discounts and shipping costs applicable to the product configuration 242.

In certain embodiments, a customer 202 and a sales representative 262 may respectively use a user device 204, 264 to interact with the collaborative product configurator system 118. As used herein, a user device 204, 264 refers to an information handling system such as a personal computer, a laptop computer, a tablet computer, a personal digital assistant (PDA), a smart phone, a mobile telephone, or other device that is capable of communicating and processing data. In certain embodiments, the user device 204, 264 may be configured to respectively present a collaborative product configurator system user interface (UI) 240, 260 to a customer 202 and a sales representative 262. In certain embodiments, the collaborative product configurator system UI 240, 260 may be implemented to present a graphical representation of a product configuration 242, which is automatically generated in response to interaction with the collaborative product configurator system 118.

In certain embodiments, the user device 204, 264 is respectively used by the customer 202 and the sales representative 262 to exchange information between the user 202, the sales representative 262, and the collaborative product configurator system 118 through a network 140. In certain embodiments, the user device 264 may be used by the sales representative 262 to exchange collaborative product configurator data with a product configuration system 250, a custom product fabrication system 252, various pricing and shipping systems 254, or a combination thereof, through the use of the network 140. In certain embodiments, the network 140 may be a public network, such as a public internet protocol (IP) network, a physical private network, a wireless network, a virtual private network (VPN), or any combination thereof. Skilled practitioners of the art will recognize that many such embodiments are possible and the foregoing is not intended to limit the spirit, scope or intent of the invention.

In certain embodiments, the graphical representation of the product configuration 242 may be presented within the collaborative product configurator system UI 240, 260 via a website 216. In certain embodiments, the website 216 may be provided by a web server 206. In certain embodiments, the web server 206 may be implemented on one or more of the product configurator system 118, the product configuration system 250, or the custom product fabrication system 252. For the purposes of this disclosure, a website 216 may be defined as a collection of related web pages which are identified with a common domain name and is published on at least one web server 206. In certain embodiments, the website 216 may be accessible via a public IP network, such as the Internet, or a private local network.

As used herein, a web page broadly refers to a document accessible via a browser which displays the web page via a display device of an information handling system. In certain embodiments, a product configuration 242 may be implemented as a web page. In certain embodiments, the web page may be implemented to include a file causing the document to be presented via the browser. In various embodiments, the web page may be implemented as a static web page, which is delivered exactly as stored on the web server 206. As an example, in certain embodiments the product configuration 242 may be presented as a static web page that a customer 202 is unable to revise, modify or otherwise alter. In certain embodiments, the web page may be implemented as a dynamic web page. In these embodiments, the web page may be dynamically updated whenever the user 202 or sales representative 262 interacts with the collaborative product configurator system 118 to revise a product configuration 242.

In certain embodiments, the web page may be implemented as a single page application. As used herein, a single page application (SPA) broadly refers to a web application or website 216 that interacts with a user, such as a customer 202 or sales representative 262, by dynamically rewriting the current page rather than loading entire new pages from a web server 206. One advantage to this approach is that it avoids interruption of the user experience between successive pages, making the web application behave more like a desktop application.

In an SPA, all necessary code (e.g., HTML, JavaScript, CSS, etc.) is either retrieved with a single page load, or the appropriate resources are dynamically loaded and added to the page as necessary, usually in response to user actions. In certain embodiments, interaction with the SPA may involve dynamic communication with the web server 206. Accordingly, the customer 202 and the sales representative 262 may iteratively interact with one another by collaboratively revising, modifying, or otherwise altering the product configuration 242, the results of which are dynamically presented within the UI of the collaborative product configurator system UI 240, 260.

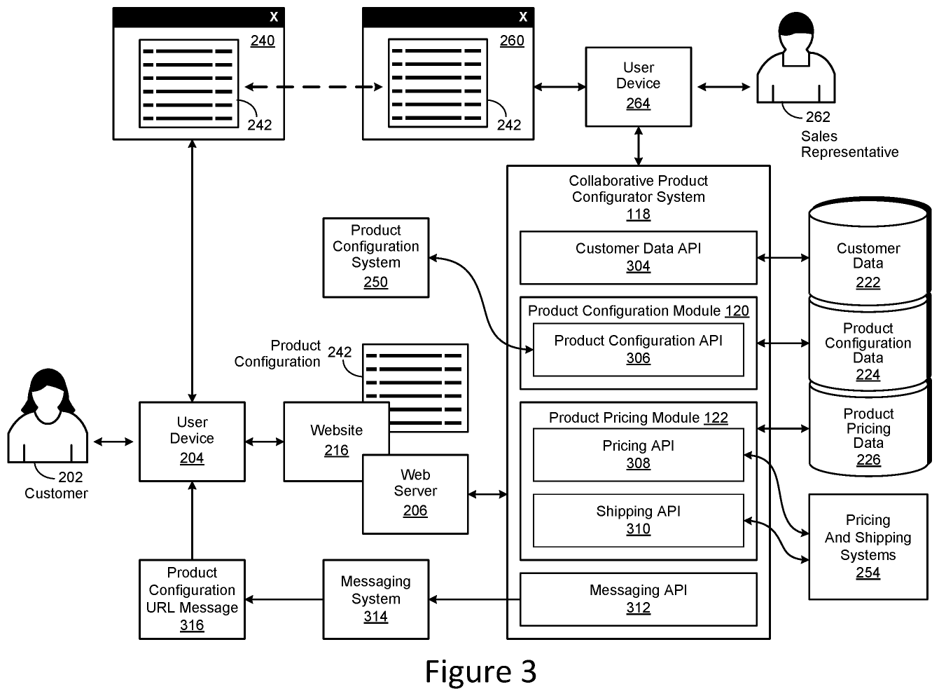

FIG. 3 shows a functional process flow diagram of the operation of a collaborative product configurator system implemented in accordance with an embodiment of the invention. In certain embodiments, a collaborative product configurator system 118 may be implemented to include a customer data 304 Application Program Interface (API), a product configuration 120 module, a pricing 122 module, and a messaging 312 API. In certain embodiments, the product configuration 120 module may be implemented to include a product configuration 306 API 306.

In certain embodiments, the product configuration API 306 may be implemented to interact with a product configuration system 250. In various embodiments, the interaction between the product configuration module 120 and the product configuration system 250 may include the provision of certain product option selection information provided by the customer 202 or the sales representative 262. In certain embodiments, product configuration system 250 may be implemented to use the provided product option selection information to generate a product configuration 242.

In certain embodiments, the product pricing module 122 may be implemented to include a pricing 308 API and a shipping 310 API. In certain embodiments, the pricing 308 and shipping 310 APIs may be implemented to interact with various pricing and shipping systems 254, as described in greater detail herein. In certain embodiments, the customer data 304 API may be implemented to interact with a repository of customer 222 data, as likewise described in greater detail herein.

In certain embodiments, the product configuration 120 and product pricing 122 modules may be implemented, as described in greater detail herein, to respectively interact with repositories of product configuration 224 and product pricing 226 data. In certain embodiments, the messaging 312 API may be implemented to interact with a messaging system 314. In certain embodiments, the messaging system 314 may be an email system, a text messaging system, or a combination thereof.

In various embodiments, the collaborative product configurator system 118 may be implemented to allow a customer 202 and a sales representative 262 to interactively configure a configurable product by collaboratively selecting certain product options, described in greater detail herein. In certain embodiments, the interactive configuration may be initiated by a customer 202 submitting a request to a sales representative 262 to collaboratively configure a product to satisfy a particular desire or need. In these embodiments, the method by which the request is submitted is a matter of design choice.

As an example, the customer 202 may place a telephone call to the sales representative 262 to discuss their needs and various product options, described in greater detail herein. As another example, the customer 202 may outline their needs or desires in an email message, which they then send to the sales representative 262. As yet another example, the customer 202 may interact with a website 216 containing various information related to one or more configurable products. In this example, the customer 202 may initially select certain product options associated with a configurable product, followed by the submission of a request to the sales representative 262 to collaboratively complete the configuration of the configurable product. Skilled practitioners of the art will recognize that many such examples are possible. Accordingly, the foregoing is not intended to limit the spirit, scope or intent of the invention.

In certain embodiments, the information associated with the submitted request may in turn be provided to the collaborative product configurator system 118, where it may be used by the sales representative 262 to generate an initial product configuration 242 for the customer 202. In certain embodiments, the resulting product configuration 242 is provided by the collaborative product configurator system 118 to a web server 206, where it may be published as a page in a particular website 216, as described in greater detail herein. In certain embodiments, the messaging 312 API may be implemented to provide the Uniform Resource Locator (URL) associated with the product configuration 242 to a messaging system 314.

In certain embodiments, the messaging system 314 may be implemented to generate an email or text message 316, or both, containing the product configuration URL. The resulting email or text message 316 is then delivered to a user device 204, described in greater detail herein, associated with the customer 202. In certain embodiments, the customer 202 may then use their user device 204 to access the URL contained in the message 316, and once accessed, the product configuration 242 is displayed within a collaborative product configurator system user interface (UI) 240. In certain embodiments, the customer 202 and sales representative 262 may respectively use their user devices 204, 264 to interact with the collaborative product configurator system 118.

In certain embodiments, the product configuration 242 displayed within the collaborative product configurator system UI 240, 260 associated with the customer's 202 and sales representative's 262 respective user device 204, 264 may change as a result of such interactions. In certain embodiments, such changes may occur in near real-time. As used herein, near real-time broadly refers to the time delay introduced by the transmission of certain information via a network 140, automated processing of such information, or a combination thereof, between the occurrence of an event and a corresponding response. In certain embodiments, the event may include the customer 202 or sales representative 262 performing a first interaction with the collaborative product configurator system 118. In certain embodiments, the response may include the customer 202 or sales representative 262 performing a second interaction with the collaborative product configurator system 118.

As an example, the sales representative 262 may change a performance parameter within the product configuration 242, which raises the unit price. In response the customer 202 may increase a quantity parameter, which results in the application of a quantity discount, which in turn lowers the unit price. In certain embodiments, revisions, modifications, alterations and other changes to a product configuration 242 may be tracked by the collaborative product configurator system 118. In certain embodiments, the collaborative product configurator system 118 may be implemented to iteratively roll back such changes to the product configuration 242 to an earlier version. In certain embodiments, the collaborative product configurator system 118 may be implemented to display deltas of such changes within the collaborative product configurator system UI 240, 260 associated with the customer's 202 and sales representative's 262 respective user device 204, 264.

As described in greater detail herein, the product configuration 242 may be implemented in certain embodiments as a static web page, which is delivered exactly as stored on the web server 206. In these embodiments, customer 202 is may be unable to revise, modify or otherwise alter the product configuration 242. Accordingly, the customer may need to contact the sales representative 262 to collaboratively select other product options, which in turn are used to generate a new version of the product configuration. In certain embodiments, the original URL associated with the product configuration 242 may be used. If so, then the revision of the product configuration 242 results in the generation of a new page, which is then within the collaborative product configurator system UI 240, 260 associated with the customer's 202 and sales representative's 262 respective user device 204, 264.

In certain embodiments, the web page may be implemented as a dynamic web page. In certain embodiments, the web page may be implemented as a single page application, described in greater detail herein. In these embodiments, the web page may be dynamically updated whenever the user 202 or sales representative 262 interacts with the collaborative product configurator system 118 to revise a product configuration 242.

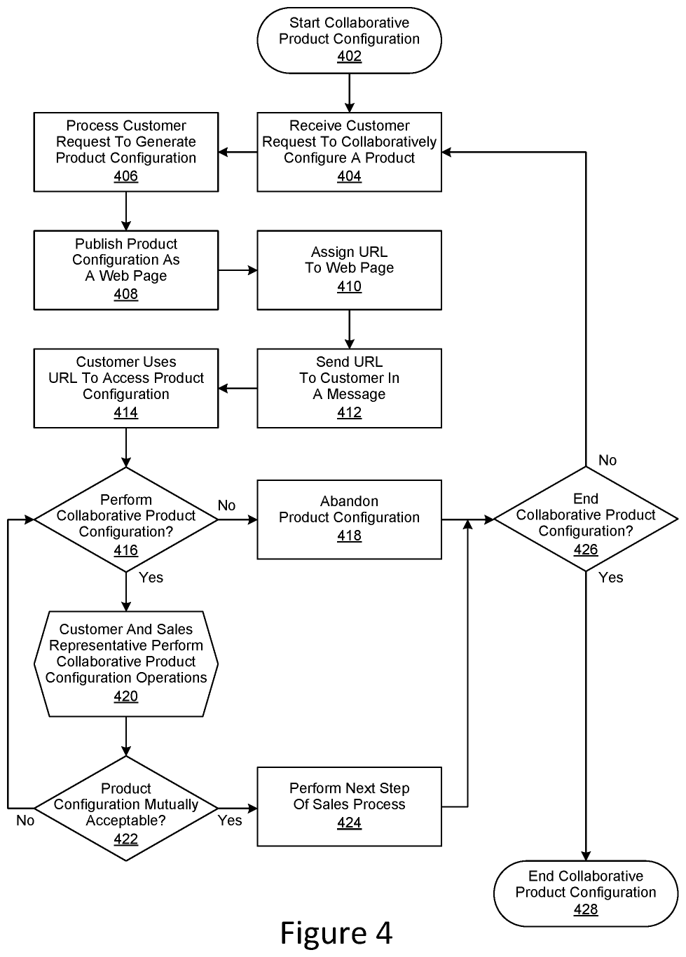

FIG. 4 is a flowchart showing the performance of collaborative product configuration operations performed in accordance with an embodiment of the invention. In this embodiment, collaborative product configuration operations are begun in step 402 with the receipt of a customer request to collaboratively configure a product. The customer request in then processed in step 406 to generate an initial product configuration. In various embodiments, the customer request may contain certain product configuration information. In certain embodiments, the product configuration information contained in a customer request may be used by a sales representative to generate the initial product configuration.

The resulting product configuration is then published as web page in step 408, as described in greater detail herein, followed by the assignment of a corresponding Uniform Resource Locator (URL) in step 410. In turn, the URL is embedded in a message and sent to the customer in step 412, likewise as described in greater detail herein, followed by the customer using the URL in step 414 to access the product configuration. A determination is then made in step 416 whether the customer wishes to collaboratively perform various product configuration operations with the sales representative, as described in greater detail herein.

If not, then the product configuration is abandoned in step 418, followed by a determination in step 426 whether to end collaborative product configuration operations. If not, then the process is continued, proceeding with step 404. Otherwise, collaborative product configuration operations are ended in step 428. However, if it was determined in step 416 that the customer wishes to collaboratively perform various product configuration operations with the sales representative, then they are performed in step 420. A determination is then made in step 422 if the result of the collaborative product configuration operations performed in step 420 are mutually acceptable. If not, then the process is continued, proceeding with step 416. If so, then the next step of the sales process is performed in step 424, and the process continues, proceeding with step 426.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

1. A computer-implementable method for performing a collaborative product configuration operation, comprising:
receiving a request from a customer to a sales representative to collaboratively configure a product;
generating a product configuration based upon the request, the generating the product configuration interacting with a product configuration system executing on a hardware processor of an information handling system;
publishing the product configuration via a collaborative product configurator system, the collaborative product configuration system performing the collaborative product configuration operation, the collaborative product configuration system comprising a product configuration module and a product pricing module, the product configuration module interacting with the product configuration system via a product configuration application program interface (API) associated with the product configuration module, the collaborative product configuration operation enabling the customer and the sales representative to interactively generate a product configuration for the product and,
fabricating the product via a custom product fabrication system, the product being fabricated according to the product configuration generated during the collaborative product configuration operation.

2. The method of claim 1, wherein:
the request includes at least one of a telephone call to the sales representative, an email message to the sales representative, and interaction with a product configurator via a web site.

3. The method of claim 1, wherein:
the publishing the product configuration comprises publishing the product configuration as a page in a web site.

4. The method of claim 3, wherein:
the publishing the product configuration comprises providing a Uniform Resource Locator (URL) associated with the product configuration to the customer.

5. The method of claim 3, further comprising:
accessing the page in the website to allow the customer to interact with the product configuration.

6. The method of claim 3, wherein:
the page comprises a dynamic web page, the dynamic web page being dynamically updated whenever the customer or the sales representative revises the product configuration.

7. A system comprising:
a processor;
a data bus coupled to the processor; and
a non-transitory, computer-readable storage medium embodying computer program code for performing a collaborative product configuration operation, the non-transitory, computer-readable storage medium being coupled to the data bus, the computer program code interacting with a plurality of computer operations and comprising instructions executable by the processor and configured for:
receiving a request from a customer to a sales representative to collaboratively configure a product;
generating a product configuration based upon the request, the generating the product configuration interacting with a product configuration system executing on a hardware processor of an information handling system;
publishing the product configuration via a collaborative product configurator system, the collaborative product configuration system performing the collaborative product configuration operation, the collaborative product configuration system comprising a product configuration module and a product pricing module, the product configuration module interacting with the product configuration system via a product configuration application program interface (API) associated with the product configuration module, the collaborative product configuration operation enabling the customer and the sales representative to interactively generate a product configuration for the product and,
fabricating the product via a custom product fabrication system, the product being fabricated according to the product configuration generated during the collaborative product configuration operation.

8. The system of claim 7, wherein:
the request includes at least one of a telephone call to the sales representative, an email message to the sales representative, and interaction with a product configurator via a website.

9. The system of claim 7, wherein:
the publishing the product configuration comprises publishing the product configuration as a page in a website.

10. The system of claim 9, wherein:
the publishing the product configuration comprises providing a Uniform Resource Locator (URL) associated with the product configuration to the customer.

11. The system of claim 9, wherein the instructions executable by the processor are further configured for:
accessing the page in the website to allow the customer to interact with the product configuration.

12. The system of claim 9, wherein:
the page comprises a dynamic web page, the dynamic web page being dynamically updated whenever the customer or the sales representative revises the product configuration.

13. A non-transitory, computer-readable storage medium embodying computer program code for performing a collaborative product configuration operation, the computer program code comprising computer executable instructions configured for:
receiving a request from a customer to a sales representative to collaboratively configure a product;
generating a product configuration based upon the request, the generating the product configuration interacting with a product configuration system executing on a hardware processor of an information handling system;
publishing the product configuration via a collaborative product configurator system, the collaborative product configuration system performing the collaborative product configuration operation, the collaborative product configuration system comprising a product configuration module and a product pricing module, the product configuration module interacting with the product configuration system via a product configuration application program interface (API) associated with the product configuration module, the collaborative product configuration operation enabling the customer and the sales representative to interactively generate a product configuration for the product and,
fabricating the product via a custom product fabrication system, the product being fabricated according to the product configuration generated during the collaborative product configuration operation.

14. The non-transitory, computer-readable storage medium of claim 13, wherein:
the request includes at least one of a telephone call to the sales representative, an email message to the sales representative, and interaction with a product configurator via a web site.

15. The non-transitory, computer-readable storage medium of claim 14, wherein:
the publishing the product configuration comprises publishing the product configuration as a page in a website.

16. The non-transitory, computer-readable storage medium of claim 15, wherein:
the publishing the product configuration comprises providing a Uniform Resource Locator (URL) associated with the product configuration to the customer.

17. The non-transitory, computer-readable storage medium of claim 15, wherein the computer executable instructions are further configured for:
accessing the page in the website to allow the customer to interact with the product configuration.

18. The non-transitory, computer-readable storage medium of claim 15, wherein:
the page comprises a dynamic web page, the dynamic web page being dynamically updated whenever the customer or the sales representative revises the product configuration.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
